(19) United States
(12) Patent Application Publication
(10) Pub. No.: US 2026/0001068 A1
(43) Pub. Date: Jan. 1, 2026

(54) CONTACTLESS BIOPARTICLE PROCESSING APPARATUS AND BIOPARTICLE PROCESSING DEVICE

(71) Applicant: CYTOAURORA BIOTECHNOLOGIES, INC., HSINCHU COUNTY (TW)

(72) Inventors: Chung-Er Huang, HSINCHU COUNTY (TW); Hsin-Cheng Ho, HSINCHU COUNTY (TW); YEN-SEN HUANG, HSINCHU COUNTY (TW); YUN-YEN HUANG, HSINCHU COUNTY (TW)

(21) Appl. No.: 18/953,698

(22) Filed: Nov. 20, 2024

Related U.S. Application Data
(60) Provisional application No. 63/665,259, filed on Jun. 28, 2024.

(51) Int. Cl. B01L 3/02

(52) U.S. Cl. CPC B01L 3/0241; B01L 2200/026; B01L 2400/0424

(57) ABSTRACT

A bioparticle processing device includes a droplet generation chamber, a working chamber in spatial communication with the droplet generation chamber, and a selection chamber that is in spatial communication with the working chamber. The droplet generation chamber is configured to receive a first liquid, a bioparticle in the first liquid, and a second liquid that is immiscible with the first liquid. The droplet generation chamber is configured to enable the second liquid to be interflowed with the first liquid, such that a part of the first liquid and the bioparticle located therein jointly form a bioparticle droplet by passing through the second liquid. The bioparticle droplet flows toward the working chamber and is configured to culture or detect the bioparticle through the part of the first liquid thereof.

### CROSS-REFERENCE TO RELATED PATENT APPLICATION

This application claims the benefit of priority to the U.S. Provisional Patent Application Ser. No. 63/665,259, filed on Jun. 28, 2024, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a bioparticle processing system, and more particularly to a contactless bioparticle processing apparatus and a bioparticle processing device.

### BACKGROUND OF THE DISCLOSURE

A conventional bioparticle processing system is operable to implement a related process on a bioparticle in liquid. However, the bioparticle tends to move with the flow of the liquid, so that the bioparticle needs to be held at a fixed position by the conventional bioparticle processing system for facilitating the implementation of the related process. Moreover, the bioparticle is easily affected or even damaged by the pressure of the liquid, regardless of whether it moves with the flow or is fixed in place. Accordingly, the conventional bioparticle processing system is not suitable for culturing of the bioparticle.

### SUMMARY OF THE DISCLOSURE

In response to the above-referenced technical inadequacies, the present disclosure provides a contactless bioparticle processing apparatus and a bioparticle processing device for effectively improving on the issues associated with conventional bioparticle processing systems.

In order to solve the above-mentioned problems, one of the technical aspects adopted by the present disclosure is to provide a contactless bioparticle processing apparatus, which includes a bioparticle processing device and a light driving device. The bioparticle processing device is configured to receive a first liquid and a second liquid that is immiscible with the first liquid. The bioparticle processing device includes a droplet generation chamber, a working chamber, and a selection chamber. The droplet generation chamber is configured to accommodate the first liquid and at least one bioparticle that is located in the first liquid. The droplet generation chamber is configured to enable the at least one bioparticle and a part of the first liquid surrounding the at least one bioparticle to jointly form a bioparticle droplet. The working chamber is in spatial communication with the droplet generation chamber. The working chamber is configured to accommodate the second liquid and the bioparticle droplet, so that the bioparticle droplet is flowable in the second liquid accommodated in the working chamber, and the part of the first liquid of the bioparticle droplet is configured to implement a culture process or a detection process on the at least one bioparticle. The selection chamber is in spatial communication with the working chamber. The selection chamber is configured to accommodate the first liquid, so that the first liquid in the selection chamber and the second liquid in the working chamber jointly form an immiscible interface therebetween. The light driving device faces toward the bioparticle processing device. The light driving device is configured to drive the bioparticle processing device to form a dielectrophoresis (DEP) pattern for moving the bioparticle droplet. The light driving device is configured to move the bioparticle droplet from the working chamber to the selection chamber through the DEP pattern, such that the part of the first liquid of the bioparticle droplet blends into the first liquid in the selection chamber for releasing the at least one bioparticle to the first liquid in the selection chamber.

In order to solve the above-mentioned problems, another one of the technical aspects adopted by the present disclosure is to provide a contactless bioparticle processing apparatus, which includes a bioparticle processing device and a light driving device. The bioparticle processing device is configured to receive a first liquid and a second liquid that is immiscible with the first liquid. The bioparticle processing device includes a droplet generation chamber, a working chamber, and a selection chamber. The droplet generation chamber is configured to accommodate the first liquid and at least one bioparticle that is located in the first liquid. The droplet generation chamber is configured to enable the at least one bioparticle and a part of the first liquid surrounding the at least one bioparticle to jointly form a bioparticle droplet. The working chamber is in spatial communication with the droplet generation chamber. The working chamber is configured to accommodate the second liquid and the bioparticle droplet, so that the bioparticle droplet is flowable in the second liquid accommodated in the working chamber, and the part of the first liquid of the bioparticle droplet is configured to implement a culture process or a detection process on the at least one bioparticle. The selection chamber is in spatial communication with the working chamber and has a releasing structure that is arranged adjacent to an edge of the working chamber. The selection chamber is configured to accommodate the second liquid. The light driving device faces toward the bioparticle processing device. The light driving device is configured to drive the bioparticle processing device to form a dielectrophoresis (DEP) pattern for moving the bioparticle droplet. The light driving device is configured to move the bioparticle droplet from the working chamber through the DEP pattern for passing through the releasing structure and further traveling into the selection chamber, such that the bioparticle droplet is broken to disperse the part of the first liquid thereof for releasing the at least one bioparticle to the second liquid in the selection chamber.

In order to solve the above-mentioned problems, yet another one of the technical aspects adopted by the present disclosure is to provide a bioparticle processing device for receiving a first liquid and a second liquid that is immiscible with the first liquid. The bioparticle processing device includes a droplet generation chamber, a working chamber, and a selection chamber. The droplet generation chamber is configured to accommodate the first liquid, at least one bioparticle located in the first liquid, and the second liquid. The droplet generation chamber is configured to enable the second liquid to interflow with the first liquid therein, so that the at least one bioparticle and a part of the first liquid jointly form a bioparticle droplet after passing through the second liquid in the droplet generation chamber. The working chamber is in spatial communication with the droplet generation chamber. The working chamber is configured to accommodate the second liquid, so that the bioparticle droplet is flowable in the second liquid accommodated in the working chamber, and the part of the first liquid of the bioparticle droplet is configured to implement a culture process or a detection process on the at least one bioparticle. The selection chamber is in spatial communication with the working chamber.

Therefore, any one of the contactless bioparticle processing apparatus and the bioparticle processing device provided by the present disclosure can be used to form the bioparticle droplet that is suspended in the second liquid, such that the at least one bioparticle can be protected by being encapsulated in the part of the first liquid, the bioparticle droplet can be quickly moved in the second liquid without damaging the at least one bioparticle, and the culture process or the detection process on the at least one bioparticle can be completely implemented during the movement of the bioparticle droplet.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a contactless bioparticle processing apparatus according to a first embodiment of the present disclosure;

FIG. 2 is a schematic longitudinal cross-sectional view of the contactless bioparticle processing apparatus of FIG. 1;

FIG. 3 is a schematic transversal cross-sectional view of the contactless bioparticle processing apparatus according to the first embodiment of the present disclosure;

FIG. 4 is a schematic transversal cross-sectional view showing the contactless bioparticle processing apparatus of FIG. 3 receiving bioparticle droplets therein;

FIG. 5 is a schematic longitudinal cross-sectional view of the contactless bioparticle processing apparatus according to the first embodiment of the present disclosure;

FIG. 6 is a schematic view showing a follow-up operation of the contactless bioparticle processing apparatus of FIG. 3;

FIG. 7 is a schematic view showing a follow-up operation of the contactless bioparticle processing apparatus of FIG. 6;

FIG. 8 is a schematic transversal cross-sectional view of the contactless bioparticle processing apparatus in another configuration according to the first embodiment of the present disclosure;

FIG. 9 is a schematic transversal cross-sectional view of the contactless bioparticle processing apparatus according to a second embodiment of the present disclosure;

FIG. 10 is a schematic longitudinal cross-sectional view of the contactless bioparticle processing apparatus of FIG. 9;

FIG. 11 is a schematic view showing a follow-up operation of the contactless bioparticle processing apparatus of FIG. 9;

FIG. 12 is a schematic longitudinal cross-sectional view of the contactless bioparticle processing apparatus of FIG. 11;

FIG. 13 is a schematic view showing a follow-up operation of the contactless bioparticle processing apparatus of FIG. 11;

FIG. 14 is a schematic longitudinal cross-sectional view of the contactless bioparticle processing apparatus of FIG. 13;

FIG. 15 is a schematic transversal cross-sectional view of the contactless bioparticle processing apparatus in another configuration according to the second embodiment of the present disclosure;

FIG. 16 is a schematic longitudinal cross-sectional view of the contactless bioparticle processing apparatus of FIG. 15;

FIG. 17 is a schematic view showing a follow-up operation of the contactless bioparticle processing apparatus of FIG. 15; and

FIG. 18 is a schematic longitudinal cross-sectional view of the contactless bioparticle processing apparatus of FIG. 17.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

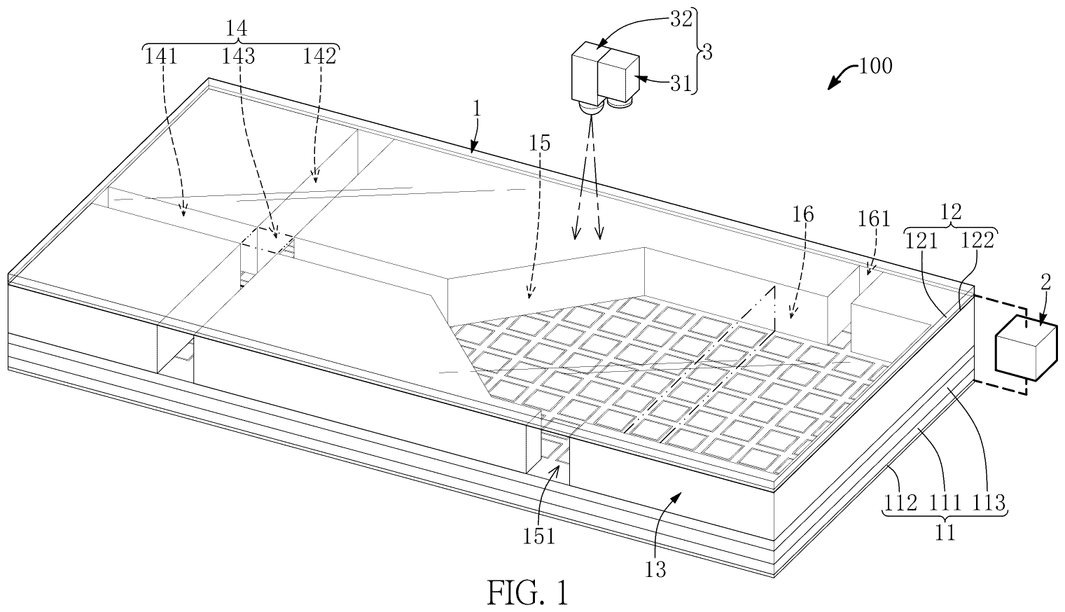

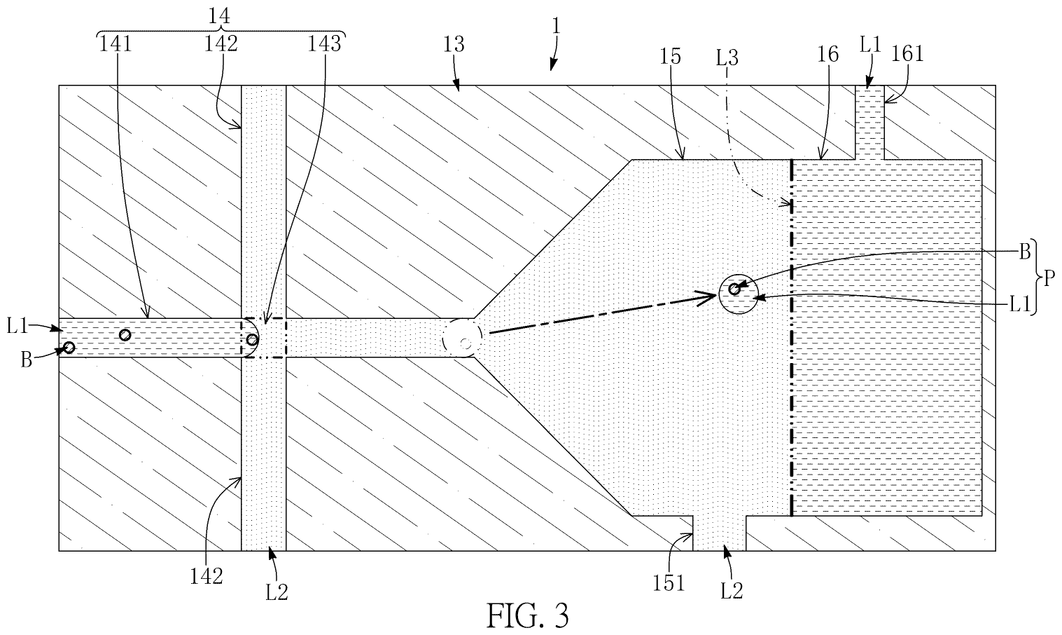

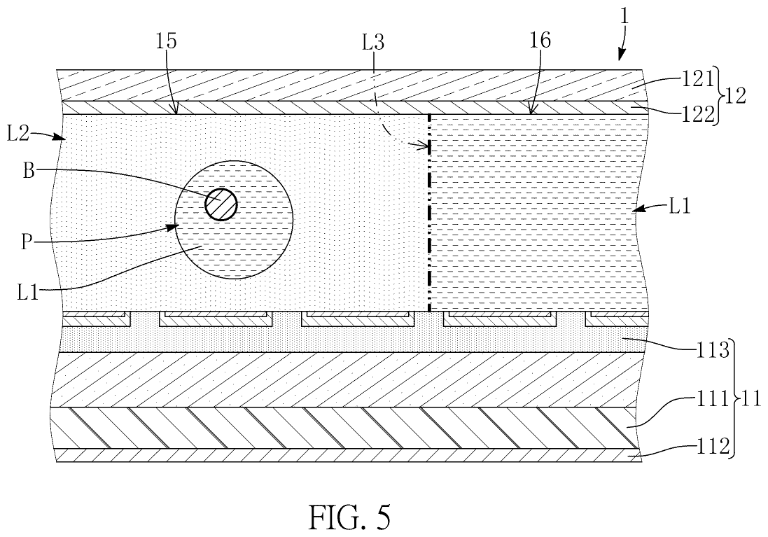

Referring to FIG. 1 to FIG. 8, a first embodiment of the present disclosure is provided. As shown in FIG. 1 to FIG. 3, the present embodiment provides a contactless bioparticle processing apparatus 100 configured to implement a culture process or a detection process on at least one bioparticle B. The at least one bioparticle B can be a specific type of cell or cell clusters, such as circulating tumor cells (CTCs), fetal nucleated red blood cells (FNRBCs), viruses, microorganisms or bacteria, but the present disclosure is not limited thereto.

The contactless bioparticle processing apparatus 100 includes a bioparticle processing device 1, an alternating current (AC) power device 2 electrically coupled to the bioparticle processing device 1, and a light driving device 3 that faces toward the bioparticle processing device 1, but the present disclosure is not limited thereto. For example, in other embodiments of the present disclosure not shown in the drawings, the bioparticle processing device 1 can be independently used (e.g., sold) or can be used in cooperation with other devices according to practical requirements.

The bioparticle processing device 1 in the present embodiment is formed at a chip-scale and is a rectangular structure, and the bioparticle processing device 1 is provided for receiving (or including) a first liquid L1, the at least one bioparticle B located in the first liquid L1, and a second liquid L2 that is immiscible with the first liquid L1. For example, the first liquid L1 can include oil and surfactant, and the second liquid L2 can be water; or, the first liquid L1 can include water and surfactant, and the second liquid L2 can be oil, but the present disclosure is not limited thereto.

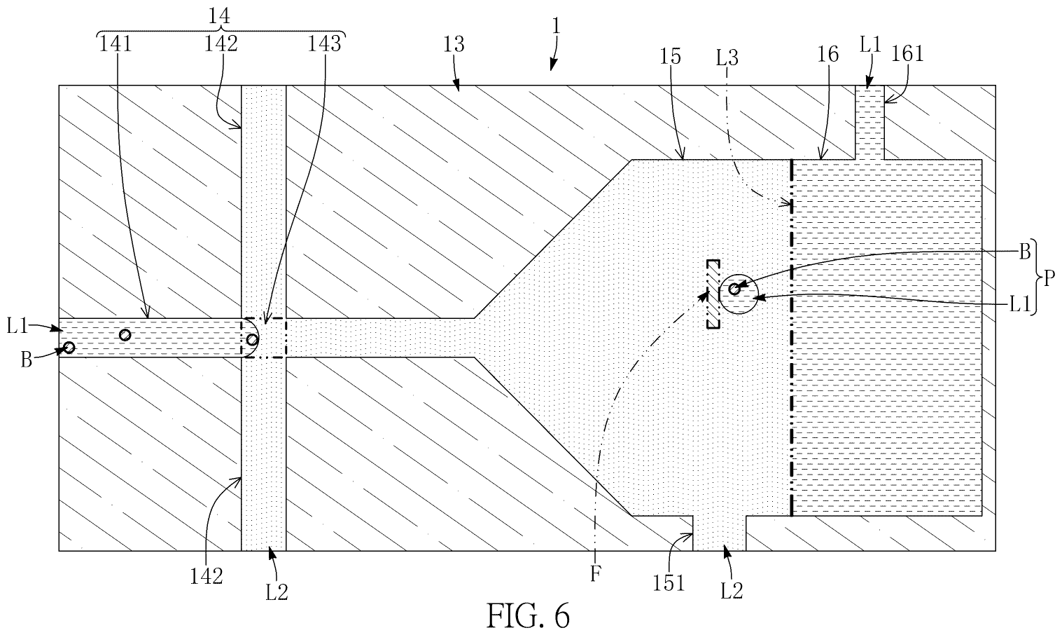

In addition, the light driving device 3 is configured to drive the bioparticle processing device 1 to form a dielectrophoresis (DEP) pattern F (as shown in FIG. 6) for moving the bioparticle droplet B. Moreover, the configuration of the bioparticle processing device 1 provided for forming the DEP pattern F is substantially described as follows, but the present disclosure is not limited thereto.

In the present embodiment, the bioparticle processing device 1 includes a light sensing module 11, a mating module 12 spaced apart from the light sensing module 11, and a bonding layer 13 that connects a peripheral portion of the light sensing module 11 and a peripheral portion of the mating module 12. At least one of the mating module 12 and the light sensing module 11 is transparent. The light sensing module 11 and the mating module 12 in the present embodiment are flat structures parallel to each other and are spaced apart from each other by a distance that is greater than a size of the at least one bioparticle B, but the present disclosure is not limited thereto.

Specifically, the light sensing module 11 includes a first substrate 111, a first electrode layer 112 formed on the first substrate 111, and a photoelectric layer 113 that is formed on the first substrate 111. In the present embodiment, the first electrode layer 112 is formed on a bottom side of the first substrate 111, the photoelectric layer 113 is formed on a top side of the first substrate 111, and the photoelectric layer 113 has a plurality of transistors 1131 being in a matrix arrangement. The photoelectric layer 113 can have a NPN transistor configuration, a PNP transistor configuration, a NP transistor configuration, or a PN transistor configuration according to practical requirements, but the present disclosure is not limited thereto.

The mating module 12 includes a second substrate 121 and a second electrode layer 122 that is formed on the second substrate 121 and that faces toward the light sensing module 11 (e.g., the photoelectric layer 113). In the present embodiment, the AC power device 2 is electrically coupled to the first electrode layer 112 of the light sensing module 11 and the second electrode layer 122 of the mating module 12.

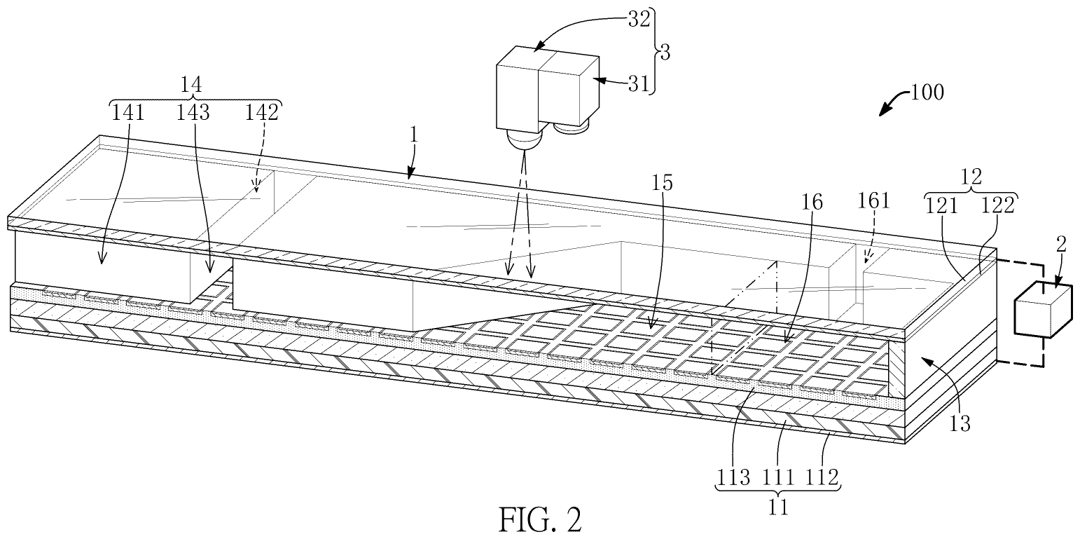

Accordingly, as shown in FIG. 2 and FIG. 5 to FIG. 7, the light sensing module 11 can be irradiated by light emitted from the light driving device 3 for forming the DEP pattern F. In the present embodiment, the light driving device 3 can include a camera 31 and a light source 32 that is in cooperation with the camera 31. The light sensing module 11 (or the photoelectric layer 113) can be irradiated by light emitted from the light source 32 of the light driving device 3 for forming the DEP pattern F.

In other words, (an interior of) the bioparticle processing device 1 includes a droplet generation chamber 14, a working chamber 15 being in spatial communication with the droplet generation chamber 14, and a selection chamber 16 that is in spatial communication with the working chamber 15. The droplet generation chamber 14, the working chamber 15, and the selection chamber 16 in the present embodiment are arranged between the light sensing module 11 and the mating module 12, and the droplet generation chamber 14 and the selection chamber 16 provided by the present embodiment are in spatial communication with two opposite sides of the working chamber 15, respectively, but the present disclosure is not limited thereto.

The droplet generation chamber 14 is configured to accommodate the first liquid L1 and the at least one bioparticle B that is located in the first liquid L1. The droplet generation chamber 14 is configured to enable the at least one bioparticle B and a part of the first liquid L1 surrounding the at least one bioparticle B to jointly form a bioparticle droplet P.

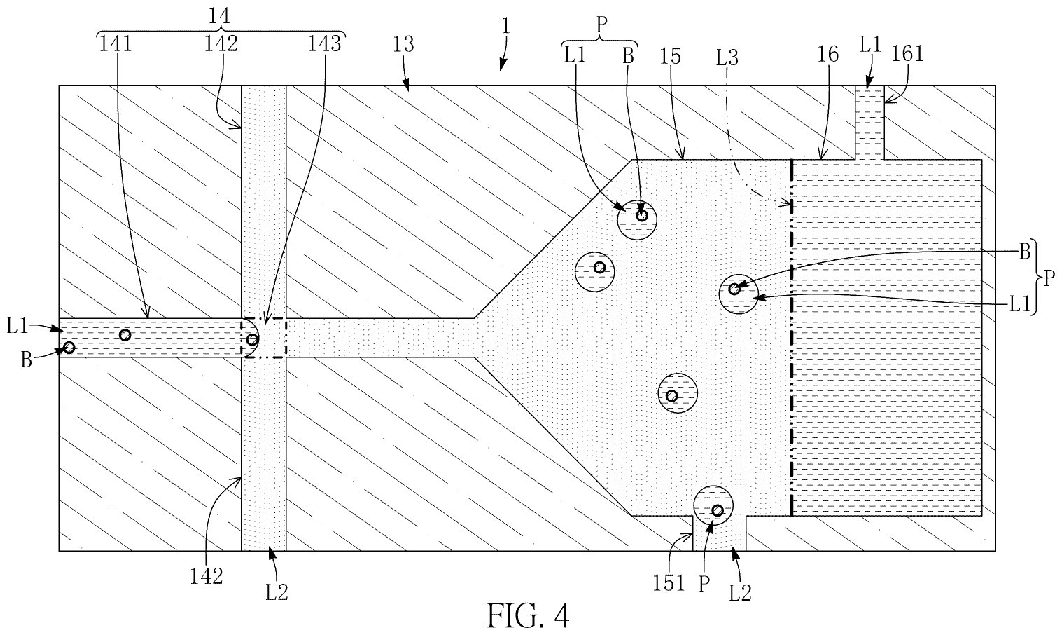

It should be noted that in order to clearly describe the present embodiment, the following description describes a quantity of the bioparticle droplet P formed in the bioparticle processing device 1 as one, but the present disclosure is not limited thereto. For example, as shown in FIG. 4, a quantity of the bioparticle droplet P formed in the bioparticle processing device 1 can be more than one, and a quantity of the at least one bioparticle B located in any one of the bioparticle droplets P can be more than one according to practical requirements.

Moreover, under the premise of the droplet generation chamber 14 being capable of forming the bioparticle droplet P, the droplet generation chamber 14 can be adjusted or designed according to practical requirements. For example, in other embodiments of the present disclosure not shown in the drawings, the droplet generation chamber 14 can disperse the first liquid L1 into a plurality of droplets in a physical manner (e.g., a stirring manner or a vibrating manner), and any one of the droplets encapsulating the at least one bioparticle B is defined as the bioparticle droplet P.

In addition, the droplet generation chamber 14 in the present embodiment is configured to form the bioparticle droplet P in a fluid manner for preventing the bioparticle B from being affected. The droplet generation chamber 14 can be configured to further accommodate and enable the second liquid L2 to interflow with the first liquid L1 therein, so that the at least one bioparticle B and the part of the first liquid L1 jointly form the bioparticle droplet P after passing through the second liquid L2 in the droplet generation chamber 14.

Specifically, the droplet generation chamber 14 includes a first channel 141 and a second channel 142 that is (perpendicularly) intersected with the first channel 141 to jointly form a confluence region 143 being in spatial communication with the working chamber 15. The first channel 141 is configured to receive the first liquid L1 and the at least one bioparticle B, and the second channel 142 is configured to receive the second liquid L2 for enabling the at least one bioparticle B and the part of the first liquid L1 to jointly form the bioparticle droplet P after passing through the confluence region 143.

The working chamber 15 is configured to accommodate the second liquid L2 and the bioparticle droplet P, so that the bioparticle droplet P is flowable in the second liquid L2 accommodated in the working chamber 15, and the bioparticle droplet P can be moved or pushed in the working chamber 15 through the DEP pattern F. Moreover, the part of the first liquid L1 of the bioparticle droplet P located in the working chamber 15 is configured to implement the culture process or the detection process on the at least one bioparticle B.

In the present embodiment, the part of the first liquid L1 of the bioparticle droplet P includes at least one of a medium, a peptide, and a recombinant protein for implementing the culture process on the at least one bioparticle B; or, the part of the first liquid L1 of the bioparticle droplet P includes at least one of a detection reagent and chemicals for implementing the detection process on the at least one bioparticle B.

In summary, the bioparticle processing device 1 in the present embodiment can be used to form the bioparticle droplet P that is suspended in the second liquid L2, such that the at least one bioparticle B can be protected by being encapsulated in the part of the first liquid L1, the bioparticle droplet P can be quickly moved in the second liquid L2 without damaging the at least one bioparticle B, and the culture process or the detection process on the at least one bioparticle B can be completely implemented during the movement of the bioparticle droplet P.

It should be noted that the working chamber 15 has an abandoned port 151. The light driving device 3 is configured to selectively move the bioparticle droplet P from the working chamber 15 to the selection chamber 16 or the abandoned port 151 through the DEP pattern F. In other words, after the culture process or the detection process on the at least one bioparticle B is completely implemented, if the culture process or the detection process results in a fail, the bioparticle droplet P is removed from the bioparticle processing device 1 through the DEP pattern F by passing through the abandoned port 151; if the culture process or the detection process results in a success, the bioparticle droplet P is moved to the selection chamber 16 through the DEP pattern F.

Specifically, the selection chamber 16 is configured to accommodate the first liquid L1, so that the first liquid L1 in the selection chamber 16 and the second liquid L2 in the working chamber 15 jointly form an immiscible interface L3 therebetween. Accordingly, the light driving device 3 is configured to move the bioparticle droplet P from the working chamber 15 to the selection chamber 16 through the DEP pattern F, such that the part of the first liquid L1 of the bioparticle droplet P blends into the first liquid L1 in the selection chamber 16 for releasing the at least one bioparticle B to the first liquid L1 in the selection chamber 16.

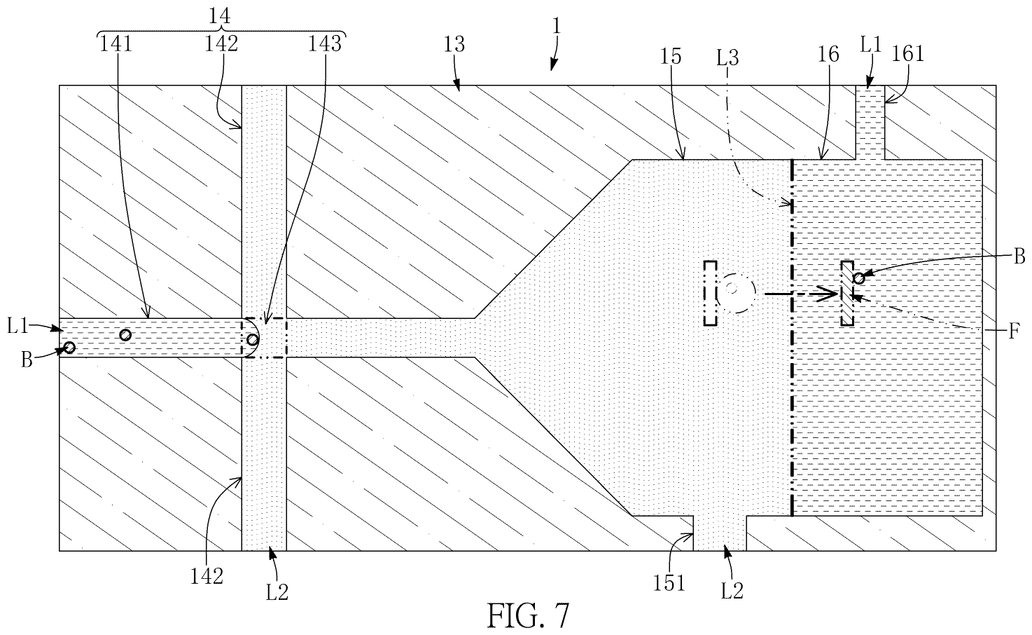

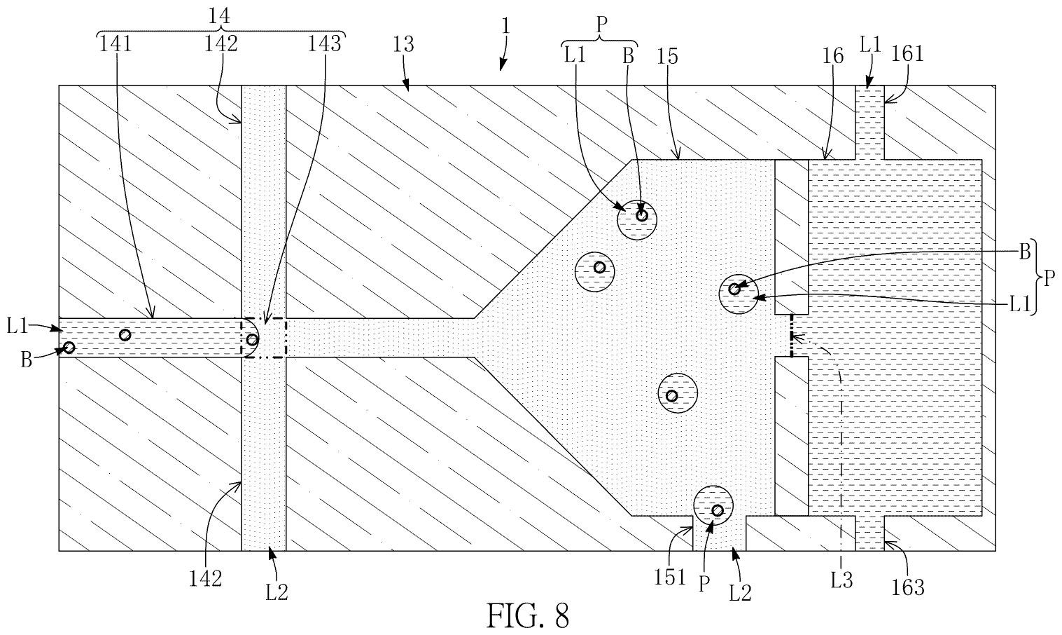

In addition, the selection chamber 16 further has a collection port 161, and the at least one bioparticle B located in the selection chamber 16 can be removed from the bioparticle processing device 1 by passing through the collection port 161. The movement of the at least one bioparticle B in the selection chamber 16 can be implemented by the DEP pattern F (as shown in FIG. 6 and FIG. 7) or a hydraulic control manner (as shown in a hydraulic control port shown in FIG. 8).

### Second Embodiment

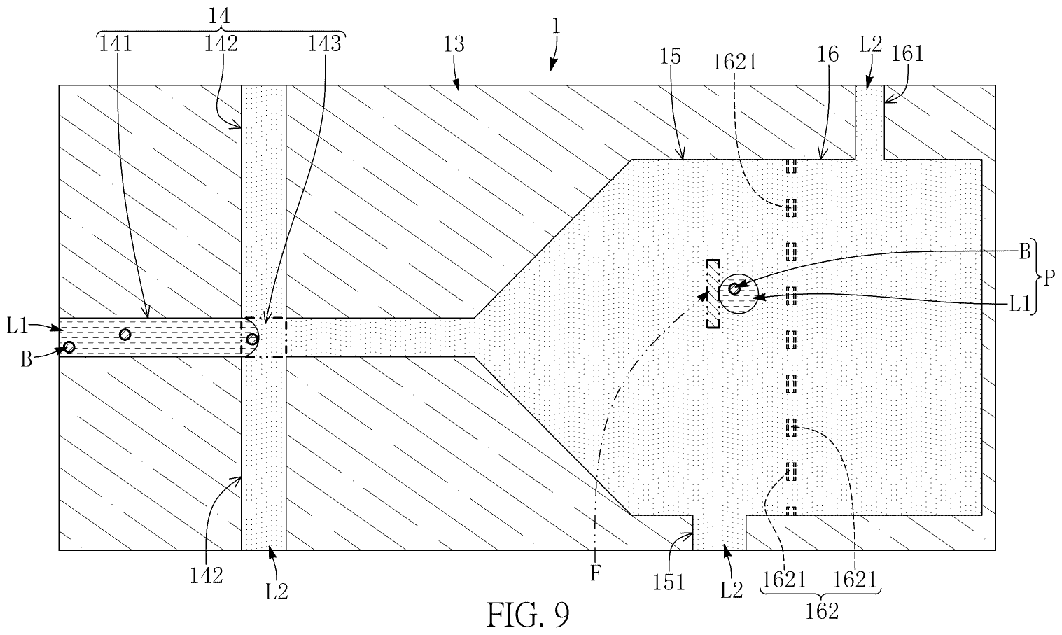

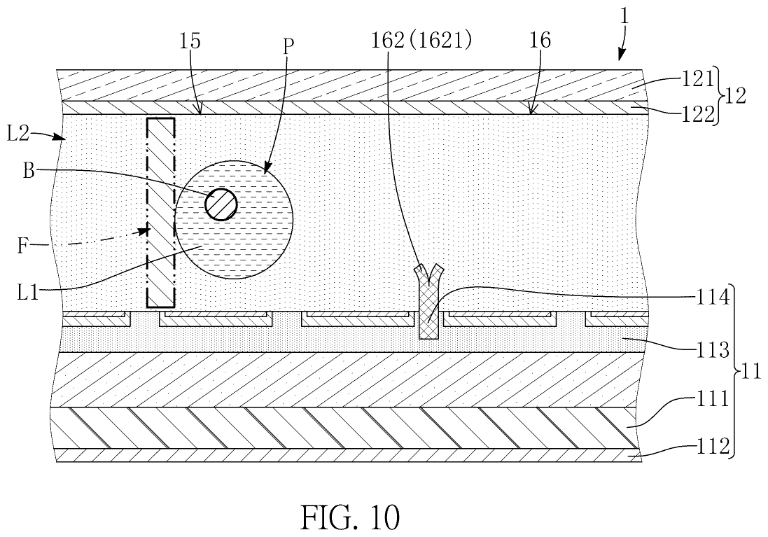

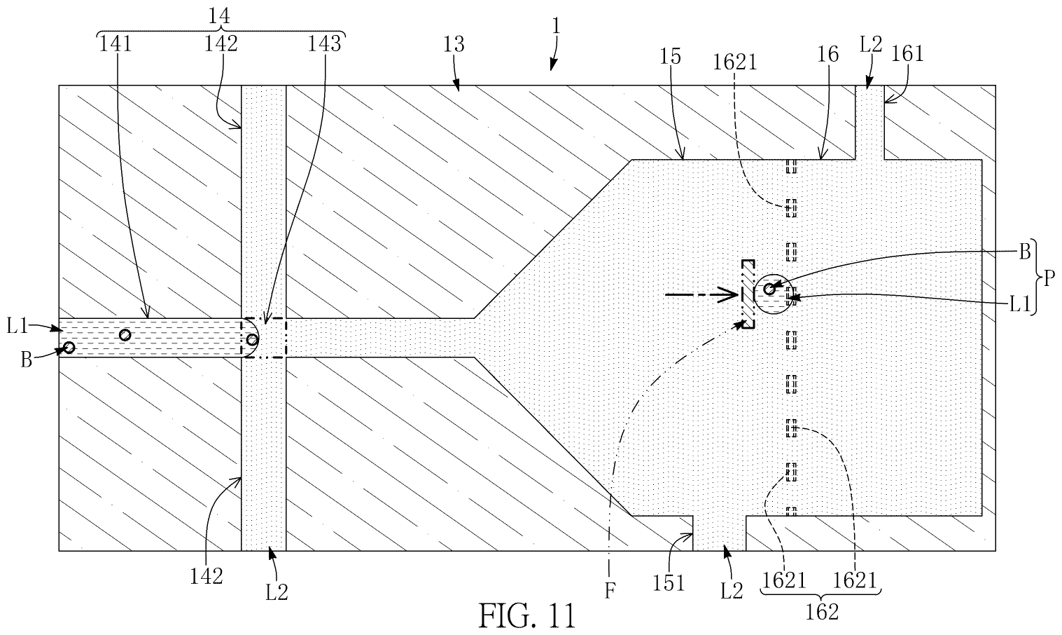

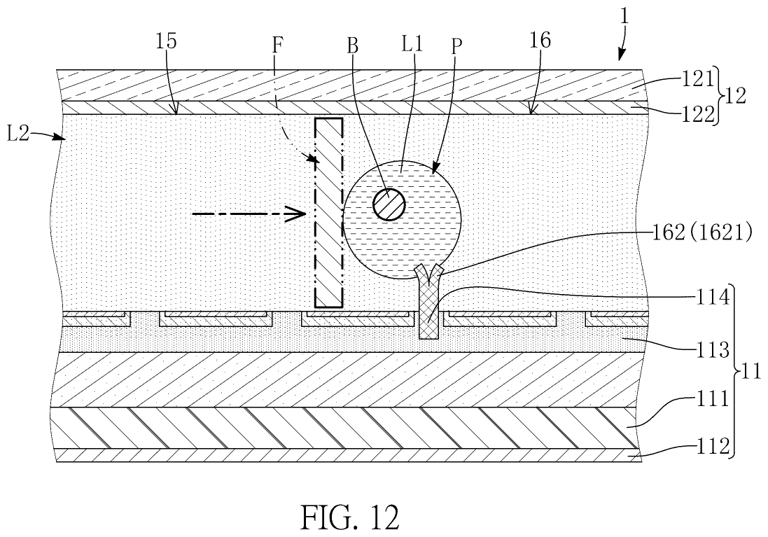

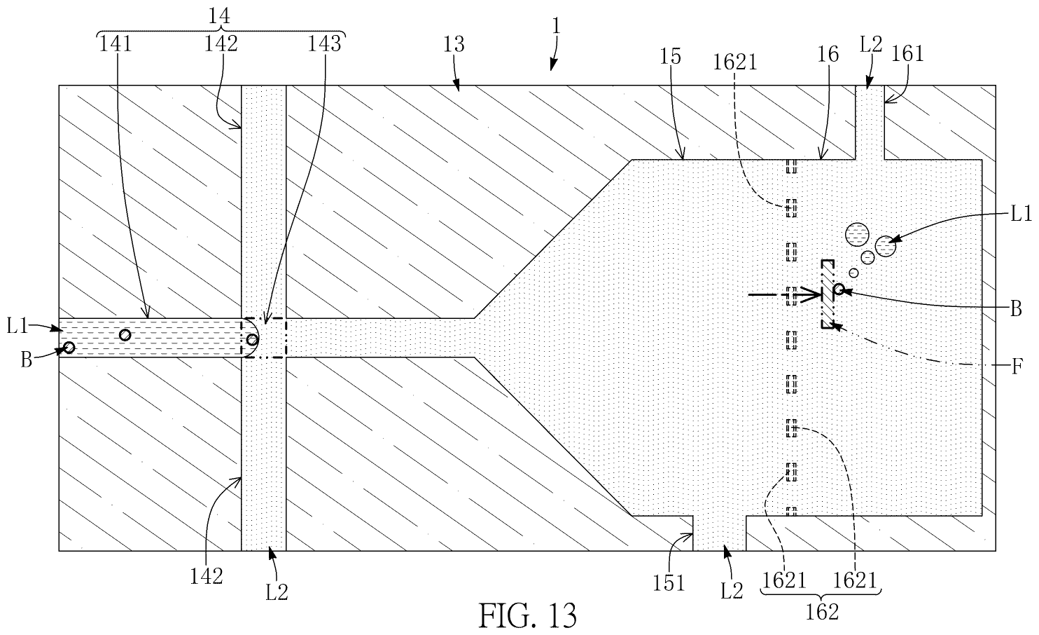

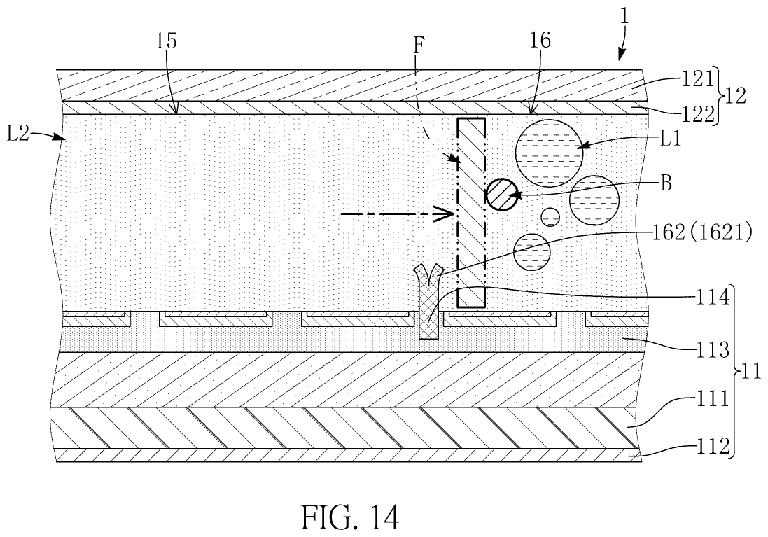

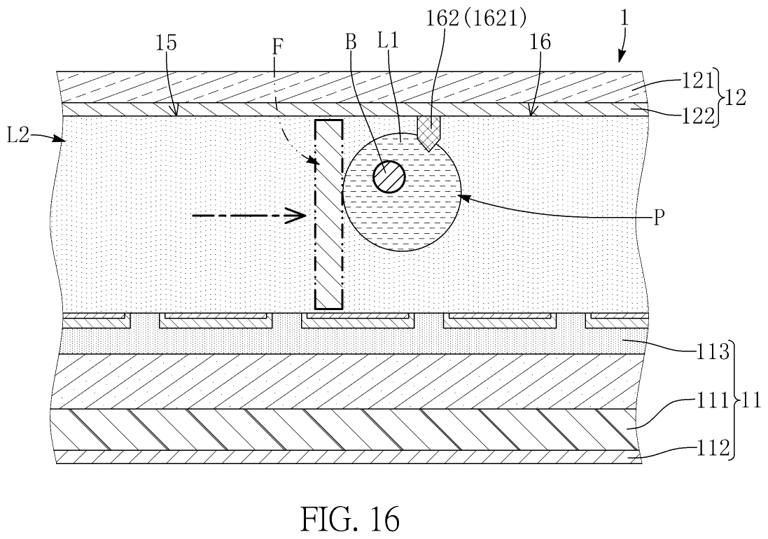

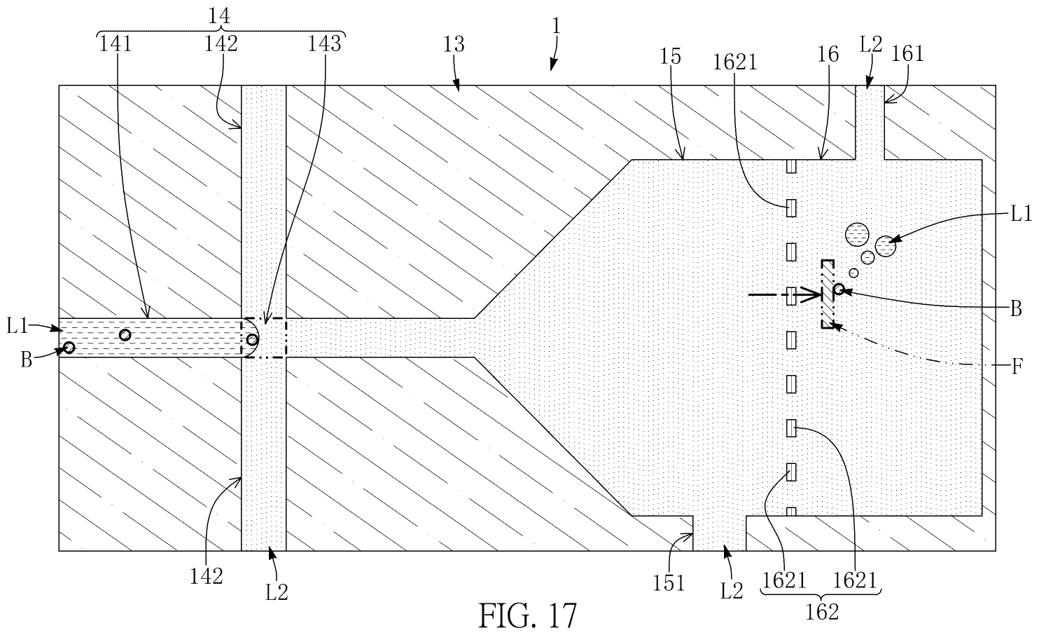

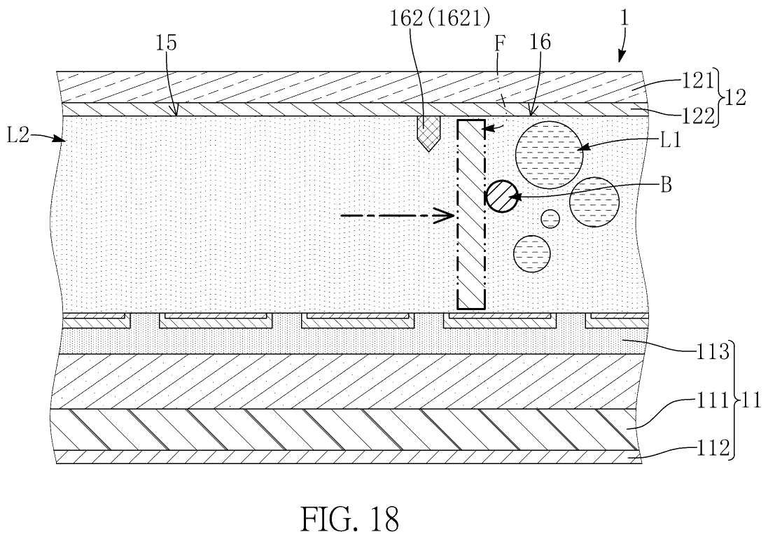

Referring to FIG. 9 to FIG. 18, a second embodiment of the present disclosure, which is similar to the first embodiment of the present disclosure, is provided. For the sake of brevity, descriptions of the same components in the first and second embodiments of the present disclosure will be omitted herein, and the following description only discloses different features between the first and second embodiments (e.g., the selection chamber 16).

In the present embodiment, the selection chamber 16 is configured to accommodate the second liquid L2, and the selection chamber 16 includes an insulating layer 114 that is formed on the photoelectric layer 113. Moreover, the selection chamber 16 has a releasing structure 162 that is arranged adjacent to an edge of the working chamber 15 for destroying a surface tension of the bioparticle droplet P. In the present embodiment, the releasing structure 162 includes a plurality of protrusions 1621 arranged along the edge of the working chamber 15, and a distance between any two of the protrusions 1621 adjacent to each other is preferably less than an outer diameter of the bioparticle droplet P, but the present disclosure is not limited thereto.

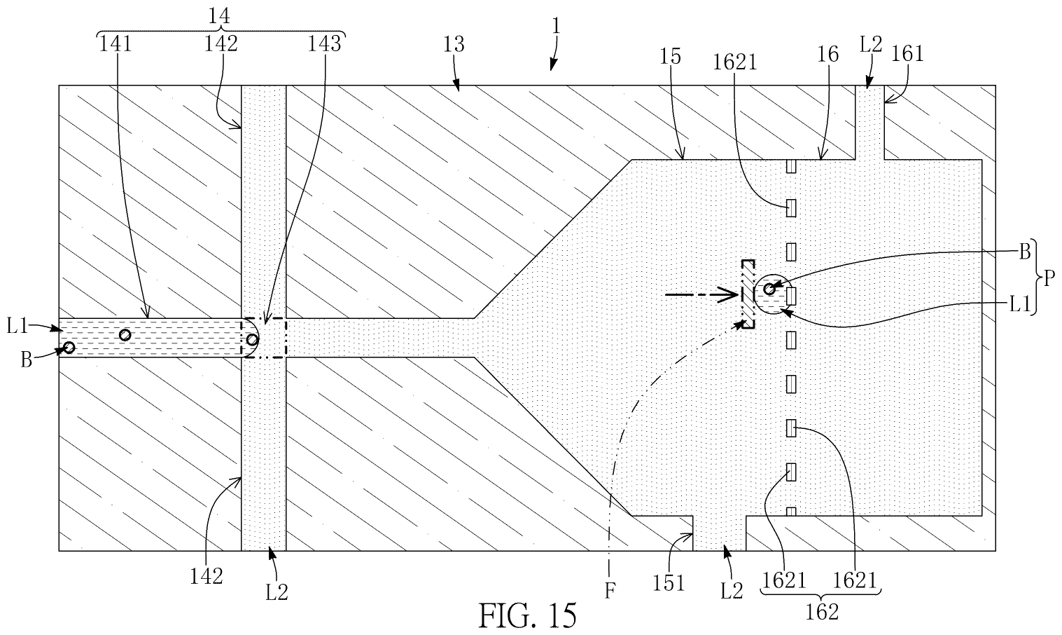

As shown in FIG. 9 to FIG. 14, when a density of the first liquid L1 is greater than a density of the second liquid L2, the bioparticle droplet P easily sinks within the second liquid L2, such that the releasing structure 162 is formed on the insulating layer 114. Moreover, as shown in FIG. 15 to FIG. 18, when a density of the first liquid L1 is less than a density of the second liquid L2, the bioparticle droplet P easily floats in the second liquid L2, such that the releasing structure 162 is formed on the mating module 12.

In summary, the light driving device 3 is configured to move the bioparticle droplet P from the working chamber 15 through the DEP pattern F for passing through the releasing structure 162 and further traveling into the selection chamber 16, such that the bioparticle droplet P is broken to disperse the part of the first liquid L1 thereof for releasing the at least one bioparticle B to the second liquid L2 in the selection chamber 16.

### Beneficial Effects of the Embodiments

In conclusion, any one of the contactless bioparticle processing apparatus and the bioparticle processing device provided by the present disclosure can be used to form the bioparticle droplet that is suspended in the second liquid, such that the at least one bioparticle can be protected by being encapsulated in the part of the first liquid, the bioparticle droplet can be quickly moved in the second liquid without damaging the at least one bioparticle, and the culture process or the detection process on the at least one bioparticle can be completely implemented during the movement of the bioparticle droplet.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A contactless bioparticle processing apparatus, comprising:
a bioparticle processing device configured to receive a first liquid and a second liquid that is immiscible with the first liquid and including:
a droplet generation chamber configured to accommodate the first liquid and at least one bioparticle that is located in the first liquid, wherein the droplet generation chamber is configured to enable the at least one bioparticle and a part of the first liquid surrounding the at least one bioparticle to jointly form a bioparticle droplet;
a working chamber being in spatial communication with the droplet generation chamber, wherein the working chamber is configured to accommodate the second liquid and the bioparticle droplet, so that the bioparticle droplet is flowable in the second liquid accommodated in the working chamber, and the part of the first liquid of the bioparticle droplet is configured to implement a culture process or a detection process on the at least one bioparticle; and
a selection chamber being in spatial communication with the working chamber, wherein the selection chamber is configured to accommodate the first liquid, so that the first liquid in the selection chamber and the second liquid in the working chamber jointly form an immiscible interface therebetween; and
a light driving device facing toward the bioparticle processing device, wherein the light driving device is configured to drive the bioparticle processing device to form a dielectrophoresis (DEP) pattern for moving the bioparticle droplet;
wherein the light driving device is configured to move the bioparticle droplet from the working chamber to the selection chamber through the DEP pattern, such that the part of the first liquid of the bioparticle droplet blends into the first liquid in the selection chamber for releasing the at least one bioparticle to the first liquid in the selection chamber.

2. The contactless bioparticle processing apparatus according to claim 1, wherein the droplet generation chamber is configured to accommodate and enable the second liquid to interflow with the first liquid therein, so that the at least one bioparticle and the part of the first liquid jointly form the bioparticle droplet after passing through the second liquid in the droplet generation chamber.

3. The contactless bioparticle processing apparatus according to claim 2, wherein the droplet generation chamber includes:
a first channel configured to receive the first liquid and the at least one bioparticle; and
a second channel that is intersected with the first channel to jointly form a confluence region that is in spatial communication with the working chamber, wherein the second channel is configured to receive the second liquid for enabling the at least one bioparticle and the part of the first liquid to jointly form the bioparticle droplet after passing through the confluence region.

4. The contactless bioparticle processing apparatus according to claim 1, wherein the working chamber has an abandoned port, and wherein the light driving device is configured to selectively move the bioparticle droplet from the working chamber to the selection chamber or the abandoned port through the DEP pattern.

5. The contactless bioparticle processing apparatus according to claim 1, wherein the part of the first liquid of the bioparticle droplet includes at least one of a medium, a peptide, and a recombinant protein for implementing the culture process on the at least one bioparticle; or, the part of the first liquid of the bioparticle droplet includes at least one of a detection reagent or chemicals for implementing the detection process on the at least one bioparticle.

6. The contactless bioparticle processing apparatus according to claim 1, wherein the bioparticle processing device includes:
a light sensing module including a first substrate, a first electrode layer formed on the first substrate, and a photoelectric layer that is formed on the first substrate; and
a mating module spaced apart from the light sensing module, wherein at least one of the mating module and the light sensing module is transparent, and the mating module includes a second substrate and a second electrode layer that is formed on the second substrate and that faces toward the light sensing module;
wherein the light driving device is configured to drive the light sensing module to form the DEP pattern by emitting light onto the light sensing module.

7. A contactless bioparticle processing apparatus, comprising:
a bioparticle processing device configured to receive a first liquid and a second liquid that is immiscible with the first liquid and including:
a droplet generation chamber configured to accommodate the first liquid and at least one bioparticle that is located in the first liquid, wherein the droplet generation chamber is configured to enable the at least one bioparticle and a part of the first liquid surrounding the at least one bioparticle to jointly form a bioparticle droplet;
a working chamber being in spatial communication with the droplet generation chamber, wherein the working chamber is configured to accommodate the second liquid and the bioparticle droplet, so that the bioparticle droplet is flowable in the second liquid accommodated in the working chamber, and the part of the first liquid of the bioparticle droplet is configured to implement a culture process or a detection process on the at least one bioparticle; and
a selection chamber being in spatial communication with the working chamber and having a releasing structure that is arranged adjacent to an edge of the working chamber, wherein the selection chamber is configured to accommodate the second liquid; and
a light driving device facing toward the bioparticle processing device, wherein the light driving device is configured to drive the bioparticle processing device to form a dielectrophoresis (DEP) pattern for moving the bioparticle droplet;
wherein the light driving device is configured to move the bioparticle droplet from the working chamber through the DEP pattern for passing through the releasing structure and further traveling into the selection chamber, such that the bioparticle droplet is broken to disperse the part of the first liquid thereof for releasing the at least one bioparticle to the second liquid in the selection chamber.

8. The contactless bioparticle processing apparatus according to claim 7, wherein the droplet generation chamber is configured to accommodate and enable the second liquid to interflow with the first liquid therein, so that the at least one bioparticle and the part of the first liquid jointly form the bioparticle droplet after passing through the second liquid in the droplet generation chamber.

9. The contactless bioparticle processing apparatus according to claim 8, wherein the droplet generation chamber includes:
a first channel configured to receive the first liquid and the at least one bioparticle; and
a second channel that is intersected with the first channel to jointly form a confluence region that is in spatial communication with the working chamber, wherein the second channel is configured to receive the second liquid for enabling the at least one bioparticle and the part of the first liquid to jointly form the bioparticle droplet after passing through the confluence region.

10. The contactless bioparticle processing apparatus according to claim 7, wherein the working chamber has an abandoned port, and wherein the light driving device is configured to selectively move the bioparticle droplet from the working chamber to the selection chamber or the abandoned port through the DEP pattern.

11. The contactless bioparticle processing apparatus according to claim 7, wherein the part of the first liquid of the bioparticle droplet includes at least one of a medium, a peptide, and a recombinant protein for implementing the culture process on the at least one bioparticle; or, the part of the first liquid of the bioparticle droplet includes at least one of a detection reagent and chemicals for implementing the detection process on the at least one bioparticle.

12. The contactless bioparticle processing apparatus according to claim 7, wherein the bioparticle processing device includes:
a light sensing module including a first substrate, a first electrode layer formed on the first substrate, a photoelectric layer formed on the first substrate, and an insulating layer that is formed on the photoelectric layer; and
a mating module spaced apart from the light sensing module, wherein at least one of the mating module and the light sensing module is transparent, and the mating module includes a second substrate and a second electrode layer that is formed on the second substrate;
wherein the light driving device is configured to drive the light sensing module to form the DEP pattern by emitting light onto the light sensing module.

13. The contactless bioparticle processing apparatus according to claim 12, wherein a density of the first liquid is greater than a density of the second liquid, and the releasing structure is formed on the insulating layer.

14. The contactless bioparticle processing apparatus according to claim 12, wherein a density of the first liquid is less than a density of the second liquid, and the releasing structure is formed on the mating module.

15. A bioparticle processing device for receiving a first liquid and a second liquid that is immiscible with the first liquid, the bioparticle processing device comprising:
a droplet generation chamber configured to accommodate the first liquid, at least one bioparticle located in the first liquid, and the second liquid, wherein the droplet generation chamber is configured to enable the second liquid to interflow with the first liquid therein, so that the at least one bioparticle and a part of the first liquid jointly form a bioparticle droplet after passing through the second liquid in the droplet generation chamber;
a working chamber being in spatial communication with the droplet generation chamber, wherein the working chamber is configured to accommodate the second liquid, so that the bioparticle droplet is flowable in the second liquid accommodated in the working chamber, and the part of the first liquid of the bioparticle droplet is configured to implement a culture process or a detection process on the at least one bioparticle; and
a selection chamber being in spatial communication with the working chamber.

16. The bioparticle processing device according to claim 15, wherein the selection chamber is configured to accommodate the first liquid, so that the first liquid in the selection chamber and the second liquid in the working chamber jointly form an immiscible interface therebetween, and wherein, when the bioparticle droplet is moved from the working chamber to the selection chamber, the part of the first liquid of the bioparticle droplet blends into the first liquid in the selection chamber for releasing the at least one bioparticle to the first liquid in the selection chamber.

17. The bioparticle processing device according to claim 15, wherein the selection chamber is configured to accommodate the second liquid, and the selection chamber has a releasing structure that is arranged adjacent to an edge of the working chamber, and wherein, when the bioparticle droplet is moved from the working chamber to the selection chamber by passing through the releasing structure, the bioparticle droplet is broken to disperse the part of the first liquid thereof for releasing the at least one bioparticle to the second liquid in the selection chamber.

18. The bioparticle processing device according to claim 17, further comprising:
a light sensing module including a first substrate, a first electrode layer formed on the first substrate, a photoelectric layer formed on the first substrate, and an insulating layer that is formed on the photoelectric layer; and
a mating module spaced apart from the light sensing module, wherein at least one of the mating module and the light sensing module is transparent, and the mating module includes a second substrate and a second electrode layer that is formed on the second substrate;
wherein a density of the first liquid is greater than a density of the second liquid, and the releasing structure is formed on the insulating layer.

19. The bioparticle processing device according to claim 17, further comprising:
a light sensing module including a first substrate, a first electrode layer formed on the first substrate, a photoelectric layer formed on the first substrate, and an insulating layer that is formed on the photoelectric layer; and
a mating module spaced apart from the light sensing module, wherein at least one of the mating module and the light sensing module is transparent, and the mating module includes a second substrate and a second electrode layer that is formed on the second substrate;
wherein a density of the first liquid is less than a density of the second liquid, and the releasing structure is formed on the mating module.

20. The bioparticle processing device according to claim 15, wherein the droplet generation chamber includes:
a first channel configured to receive the first liquid and the at least one bioparticle; and
a second channel that is intersected with the first channel to jointly form a confluence region that is in spatial communication with the working chamber, wherein the second channel is configured to receive the second liquid for enabling the at least one bioparticle and the part of the first liquid to jointly form the bioparticle droplet after passing through the confluence region.
